(19) United States
(12) Patent Application Publication
(10) Pub. No.: US 2007/0262701 A1
(43) Pub. Date: Nov. 15, 2007

(54) Mesh Structure For Large-Scale Display Screen

(76) Inventors: Tsung-I Wang, Taoyuan Hsien (TW); Tsung-Chih Wang, Taoyuan Hsien (TW)

Correspondence Address: LIN & ASSOCIATES INTELLECTUAL PROPERTY, P.O. BOX 2339, SARATOGA, CA, 95070-0339, US

(21) Appl. No.: 11/745,622

(22) Filed: May 8, 2007

(30) Foreign Application Priority Data
May 9, 2006 (TW) 095116378

(51) Int. Cl. H05B 33/00

(52) U.S. Cl. 313/500; 313/505; 315/169.3

(57) ABSTRACT

A mesh structure for a large-scale display screen having a resolution of (n×m, n, m>1) is provided herein, which formed by weaving or braiding (i+j, i, j>1) linear members. (n×m) lighting units are then individually and fixedly positioned on the mesh structure with a substantial uniform distance among them. Signal and power cables are then laid out along the linear members to connect the lighting units for the delivery of video signal and electricity. The light units function as the display screen's pixels and the distance between adjacent lighting units is the pitch of the display screen.

### BACKGROUND OF THE INVENTION

1. Field of the Invention

The present invention generally relates to large-scale display screens, and more particularly to a large-scale display screen formed by weaving linear members into two-dimensional or three-dimensional mesh structure and positioning lighting units on the mesh structure.

2. The Prior Arts

As light emitting diodes (LEDs) are continuously improved in terms of their brightness, robustness, and operation life, the application of LEDs in in-door or out-door large-scale display screen has been gaining popularity.

Conventionally, these large-scale display screens are formed by piecing together a large number of modules and there are signal and power cables connecting these module for the delivery of electricity and video signal. For example, a module could contain 16×16=256 sets of red, green, and blue LEDs, and circuit boards where the sets of LEDs are positioned. In order to provide superior visibility and resolution, usually a large number of modules are required for a large-scale display screen and, to withstand vibration from earthquake and wind and to sustain dampness from rain, these modules are usually affixed to a rigid base and completely covered with water-proof adhesives. As such, each module has a significant weight and even more so when they are pieced together into the large-scale display screen.

This makes the construction of the large-scale display screen very difficult. In addition, when the large-scale display screen is installed on the walls of a building, a frame for supporting the large-scale display screen has to be built destructively on the walls. As the modules are almost without exception opaque (more often they are coated with black paint to enhance the contrast of the display screen), not only the view from within the building is obstructed, but also the lighting condition inside the building is significantly impacted. When the large-scale display screen is not turned on, the appearance of the building is severely affected by the presence of the large-scale display screen.

Further more, the shape of the large-scale display screen is rather inflexible. The large-scale display screen is difficult to form into shapes other than rectangle and, once it is constructed, it is difficult, if not impossible, to make any change to the large-scale display screen.

### SUMMARY OF THE INVENTION

Accordingly, the present invention provides a novel structure for the large-scale display screen which is not only easy to construct, low-cost, and robust to natural factors such as wind, rain, dust, and earthquake. The display screen according to the present invention renders insignificant impact to the appearance, view, and light condition of the building. The display screen can also be flexibly and easily constructed into a special two-dimensional or three-dimensional shape conforming to the appearance of the building or certain special requirement up to more than 5,000 m².

To achieve the foregoing objectives, the conventional concept of piecing together large number of sizable modules must be abandoned. And, to minimize the impact to the appearance, view, and lighting condition of the building, the percentage of the display screen's opaque area to the entire display screen should be as small as possible. Therefore, a mesh structure for a large-scale display screen having a resolution of (n×m, n, m>1) is provided herein, is formed by weaving or braiding (i+j, i, j>1) linear members. The mesh structure further contains (nxm) lighting units, and a plurality of signal and power cables. The (n×m) lighting units are individually and fixedly positioned on the mesh structure with a substantial uniform distance among them. The signal and power cables are laid out along the linear members to connect the lighting units for the delivery of video signal and electricity. For a display screen as such constructed, the light units function as the display screen's pixels and the distance between adjacent lighting units is the pitch of the display screen.

For the linear members forming the mesh structure, in one embodiment, (i) members are aligned in parallel along a direction while the other (j) members are aligned in parallel along another direction. Each of the (i+j) members is stretched from its two ends by appropriate and opposite forces. In another embodiment, (i) members are aligned in parallel along a direction and stretched with opposite forces. The other (j) members are aligned in parallel along another direction and braided through the (i) members, respectively. In yet another embodiment, each linear member has two adjacent members, except those members at the borders of the mesh structure. Then, each linear member is braided back and forth with the two adjacent members.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a schematic diagram showing the mesh structure of a large-scale display screen according to a first embodiment of the present invention from a front view.

FIG. 1b is a schematic diagram showing the mesh structure of a large-scale display screen according to a second embodiment of the present invention from a front view.

FIG. 1c is a schematic diagram showing the mesh structure of a large-scale display screen according to a third embodiment of the present invention from a front view.

FIG. 1d is a schematic diagram showing the mesh structure of a large-scale display screen according to a fourth embodiment of the present invention from a front view.

FIG. 1e is a schematic diagram showing the mesh structure of a large-scale display screen according to a fifth embodiment of the present invention from a front view.

FIG. 2a is a schematic diagram showing the intersection of the linear members according to an embodiment of the present invention from a front view.

FIG. 2b is a schematic diagram showing the intersection of the linear members according to another embodiment of the present invention from a front view.

FIG. 2c is a schematic diagram showing the intersection of the linear members according to yet another embodiment of the present invention from a front view.

FIGS. 3a and 3b are schematic diagrams showing semi-spherical lighting units provided on the intersections of the linear members from a front view and a profile view, respectively.

FIGS. 3c and 3d are schematic diagrams showing two embodiments of positioning lighting units inside the grids of the linear members from a front view, respectively.

FIG. 4 is a schematic diagram showing the concavity of the mesh structure under the direct influence of the wind from a profile view.

FIG. 5 is a schematic diagram showing the windings of the signal and power cables around the linear members from a front view.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

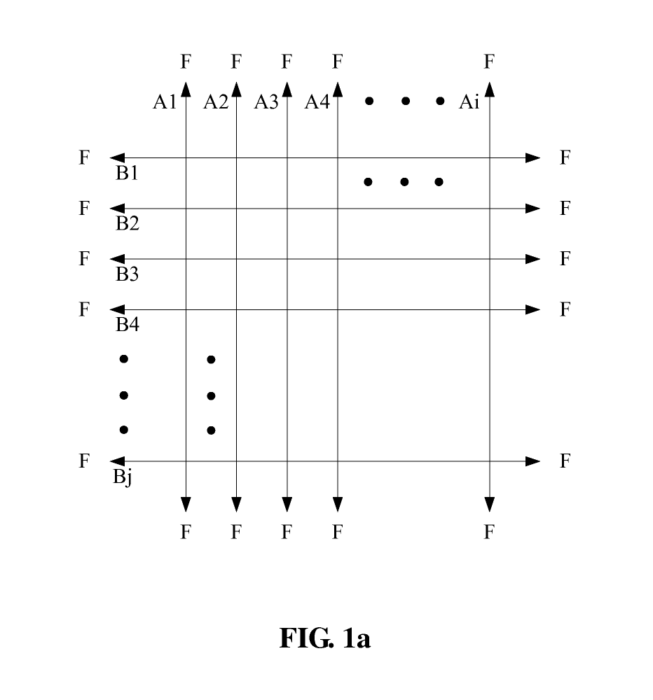

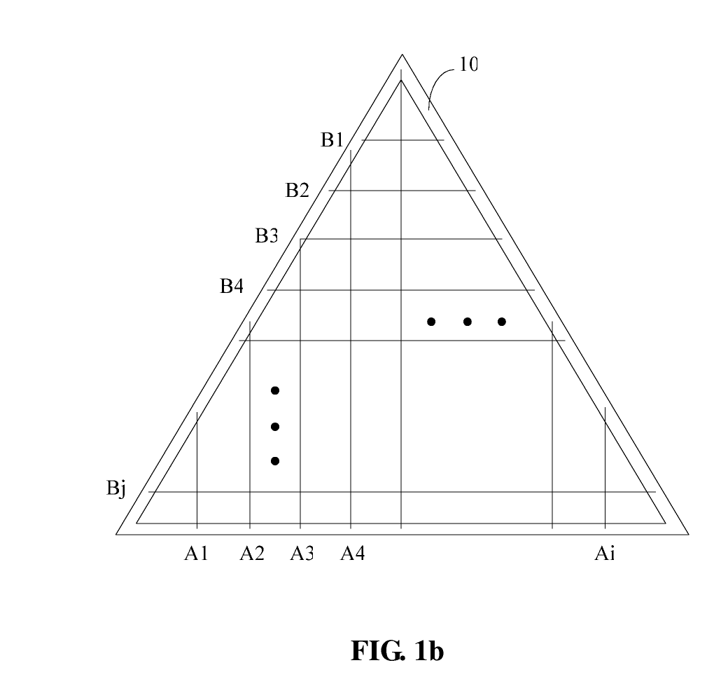

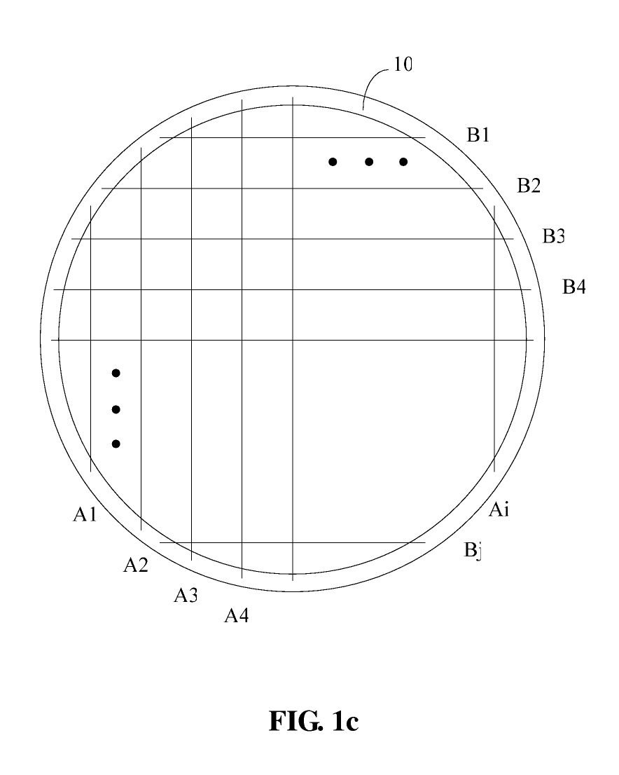

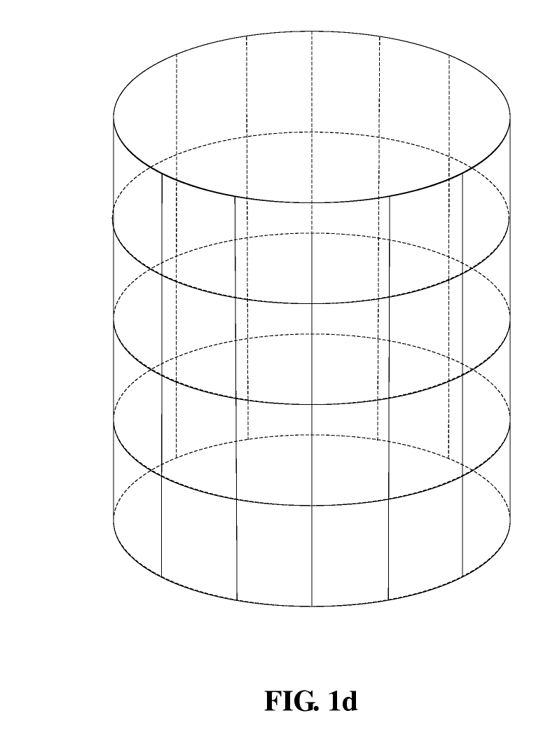

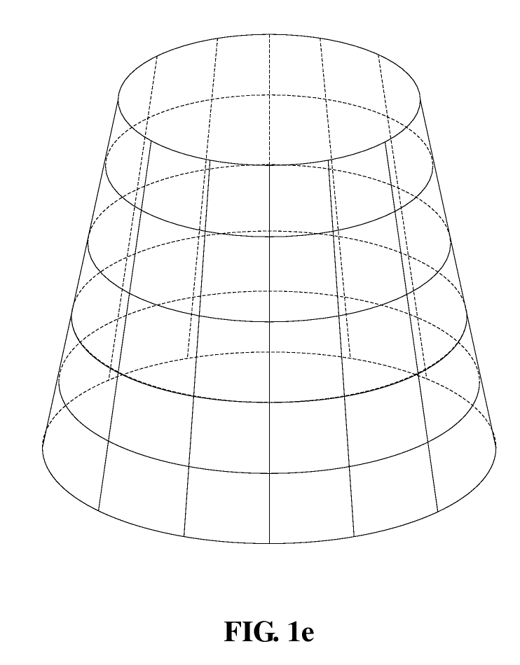

FIG. 1a is a schematic diagram showing the mesh structure of a large-scale display screen according to a first embodiment of the present invention. As illustrated, the present embodiment contains (i+j) tenacious linear members A1˜Ai and B1˜Bj formed into a planar, rectangular mesh structure. The linear members A1˜Ai and B1˜Bj can be nylon polymer wires, Kevlar polymer wires, or steel wires, and an appropriate means is adopted to apply opposite forces F at the two ends of the linear members A1˜Ai and B1˜Bj. For example, as shown in FIG. 1a, the linear members A1˜Ai and B1˜Bj have their two ends bound to two opposing edges of a frame, respectively, so as to provide the stretching forces. The forces should be strong enough to prevent the wind from creating ripples on the display screen. On the other hand, the forces shouldn't be too strong for the linear members to bear. Assuming that Kevlar wires are used, a linear member having a diameter of 1 mm can withstand more than 150 Kg force.

The mesh structure is not required to have a specific shape, as long as the linear members are stretched by appropriate forces from the linear members' two ends. The linear members are also not limited to be aligned in horizontal and vertical directions (relative to the ground) only. For example, in the two embodiments shown in FIGS. 1b and 1c, the linear members A1˜Ai and B1˜Bj are stretched into a triangular shape or a circular shape by frames 10. A planar mesh structure such as those just described can be installed along a wall outside or inside a building; it can even be installed under the ceiling or in the air as a canopy. When it is installed in-door or when strong wind is of no concern, the vertical linear members A1˜Ai can be stretched by having their top ends fixed and having their other ends pulled by weights or by gravity. This type of mesh structures enjoys great application flexibility in that they can be rolled up when not in use and expanded when needed.

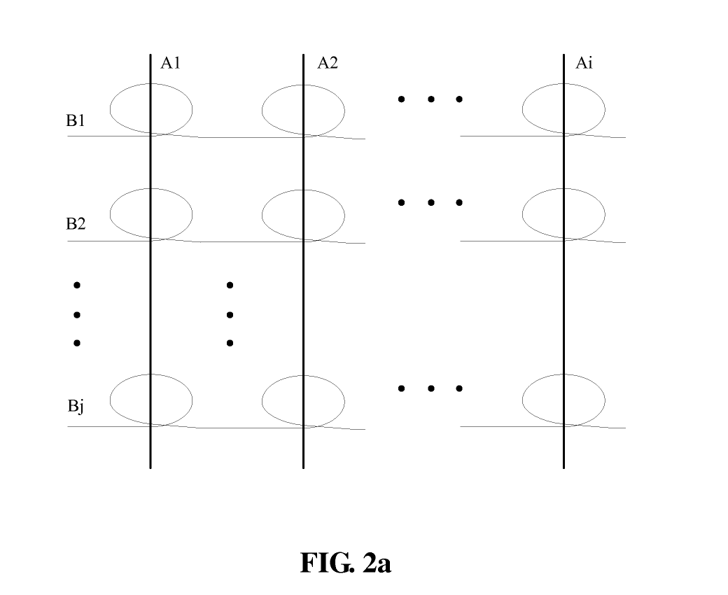

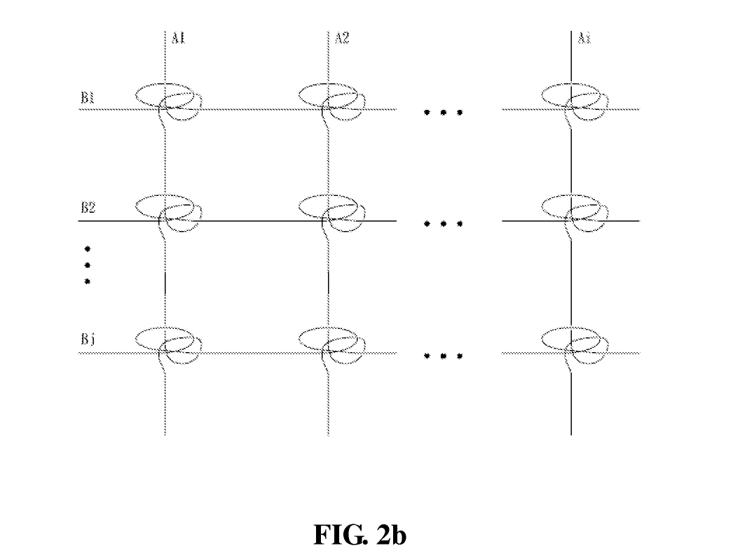

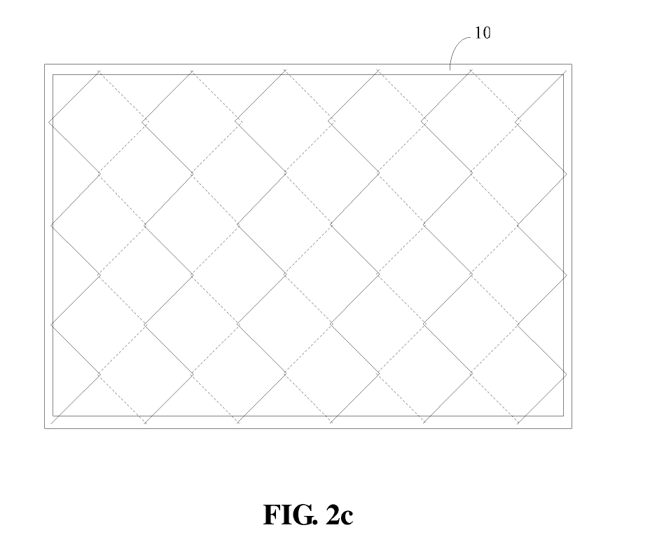

FIG. 2a is a schematic diagram showing the intersection of the linear members according to an embodiment of the present invention. As illustrated, for linear members aligned in one direction, they are wound around the linear members aligned in another direction at where they intersect so as to enhance the strength of the mesh structure. As shown in FIG. 2b, it is also possible that linear members are entwined together at their intersection. Please note that what are shown in FIGS. 2a and 2b are especially simplified for the sake of illustration and there are various other possible ways of winding of the linear members. If the linear members are wound as described, the mesh structure of the present invention can have only the linear members in one direction stretched and the linear members of the other direction are not stretched but wound around the former ones. In this way, the mesh structure can be flexibly formed into various three-dimensional planes. For example, as shown in FIGS. 1d and 1e, the vertical linear members are stretched and the horizontal linear members are wound around the vertical linear members (the details of the intersections are omitted), so as to jointly form the circumferential planes of a cylinder and a cone, respectively.

Generally, all the foregoing embodiments contains two sets of linear members intersect with each other orthogonally or at other angles. There are also embodiments where the linear members are basically aligned in one direction. For example, as shown in FIG. 2c, each linear member has two adjacent members, except those members at the borders of the mesh structure. Then, a linear member (e.g., one of the physical lines shown in FIG. 2c) is braided back and forth with the two adjacent members (e.g., the dotted lines shown in FIG. 2c). In other words, the linear member intersects with the linear member at its one side, and then turns to intersect the linear member at the other side, and then goes back and forth in this manner. For the linear members at the borders, they intersect the linear members besides them and then turn to connect the frame 10 and then go back and forth in this manner. Please note that in these embodiments the linear members can also be wound around with each other at the intersections.

In summary, the mesh structure of the present invention is constructed as follows. For a large-scale display screen having a resolution of (n×m, n, m>1), the mesh structure contains (i+j, i, j>1) tenacious linear member weaved or braided into a two-dimensional or three-dimensional plane. For the linear members, in one embodiment, (i) members are aligned substantially in parallel along a direction while the other (j) members are aligned substantially in parallel along another direction. Each of the (i+j) members is stretched from its two ends by appropriate and opposite forces (such as those shown in FIGS. 1a, 1b, and 1c). In another embodiment, (i) members are aligned substantially in parallel along a direction and stretched with opposite forces. The other (j) members are aligned substantially in parallel along another direction and braided through the (i) members, respectively (such as those shown in FIGS. 1d and 1e). In yet another embodiment, each linear member has two adjacent members, except those members at the borders of the mesh structure. Then, each linear member is braided back and forth with the two adjacent members (such as the one shown in FIG. 2c).

Regardless of how the linear members are weaved or braided, the mesh structure formed could be a two-dimensional plane (such as those shown in FIGS. 1a, 1b, and 1c) or a three-dimensional plane (such as those shown in FIGS. 1d and 1e). The pixels of the large-scale display screen are implemented by a number of lighting units. For a large-scale display screen having a resolution of (n×m), the mesh structure therefore requires (n×m) lighting units individually and fixedly positioned on the two-dimensional or three-dimensional plane. There are basically two ways to fix a lighting unit to the mesh structure. In one approach, the lighting unit is installed at the intersection of two linear members; in the other approach, the lighting unit is installed inside a grid of the mesh structure. Regardless of the installation approaches, there is a substantially uniform distance P among adjacent lighting units. The distance P is equivalent to the pitch of the large-scale display screen. There is no specific requirement on the distance P and it is determined primarily based on the application intended. For example, in order to form a large-scale display screen having a dimension (30 m×30 m) and a resolution (500×600), the distance P is about 6 cm. As mentioned earlier that, for linear members using Kevlar wires, a linear member having a diameter of 1 mm can withstand a force up to 150 kg. Compared to the 6 cm distance, the linear members are extremely thin and it should be clear why the mesh structure of the present invention delivers minimized impact to the view and lighting condition from inside a building.

Additional details about the present invention are as follows. Each lighting unit contains an appropriate number of LEDs having an appropriate light color combination. These LEDs are configured on a circuit which also contains logic circuit for video signal processing and power circuit. Assuming that a lighting unit contains three LEDs, one red-light, one blue-light, and one green-light, the three LEDs can be configured within a (6 mm×6 mm) area according the technology of present day. The logic circuit and power circuit mainly contain miniature ICs whose dimensions are also about (3 mm×3 mm). In total, the circuit for the LEDs and the logic and power circuits can be designed to be within (1 cm×1 cm). The details about the circuit board are omitted here as they are not the subject matter of the present invention and should be well known to people of related arts.

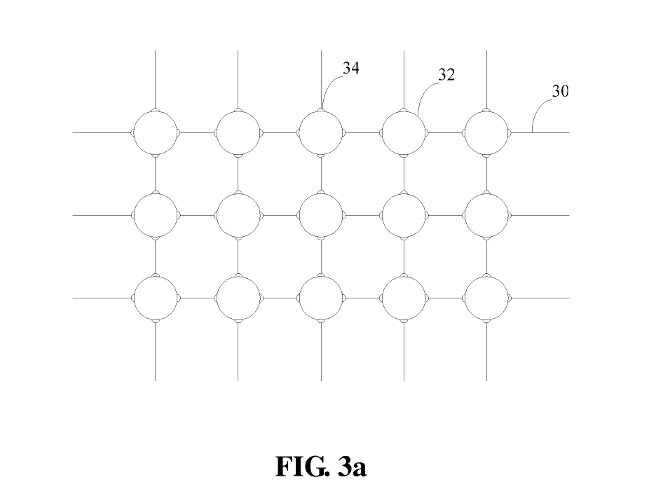

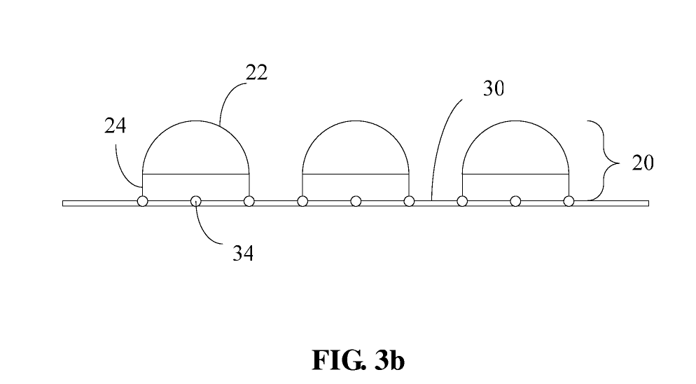

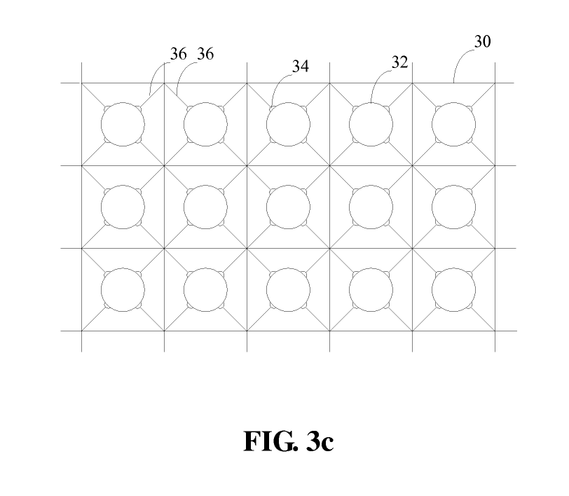

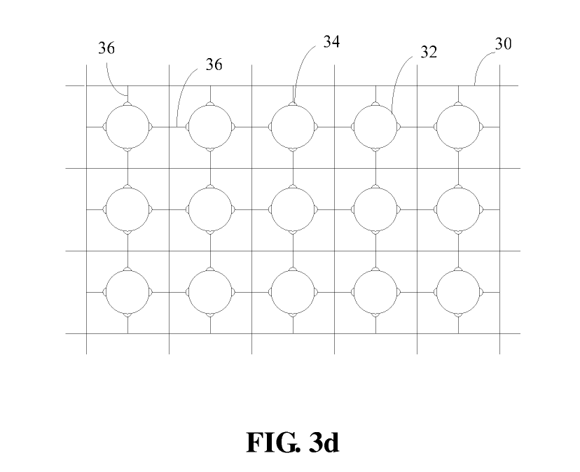

The circuit board of each lighting unit is housed inside a rigid, air-tight protection structure. The protection structure could have a cubic, cylindrical, spherical, or other appropriate shape. A spherical or semi-spherical protection structure is preferable as it provides a smaller wind resistance. FIGS. 3a and 3b are schematic diagrams showing semi-spherical lighting units 32 provided on the intersections of the linear members from a front view and a profile view, respectively. As shown in FIG. 3b, the protection structure 20 contains a transparent dome 22 to allow the light beams of the LEDs to emanate through and a circular base 24 to accommodate the circuit board. As also shown in FIG. 3a, the base 24 is fixedly attached to four locations 34 on the intersecting linear members 30. As such, the weight of the lighting unit 32 is evenly distributed and the orientation of the lighting unit 32 is secured. In other words, the light unit 32 is fixed by at least three points (so as to make up a plane) around the intersection point on the intersecting linear members. The dome 22 is usually made of a transparent plastic material and is tightly joined to the base 24. Further, the dome 22 can be filled with anti-water glue or adhesive so as to prevent the invasion of moisture and dust. Using the aforementioned mesh structure whose distance among lighting units 32 is (6 cm) as example, lighting units 32 having a diameter of (1 cm) will only takes 3% of the area, again confirming that the mesh structure of the present invention delivers minimum interference to the view and lighting condition. Please note that the foregoing approach to position the lighting units is only exemplary and it is not intended to limit the present invention.

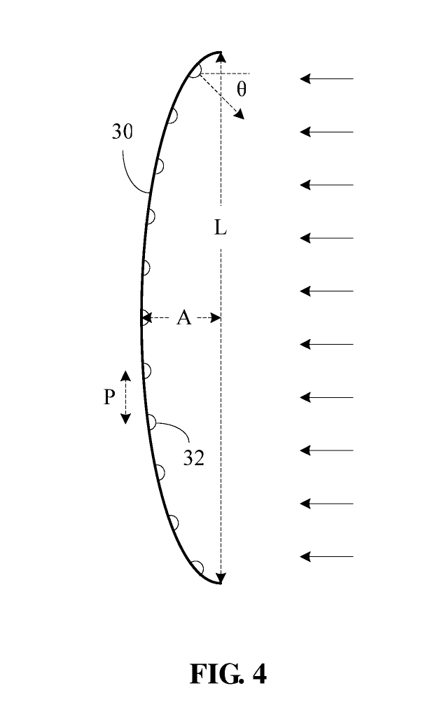

As to the influence of the wind to the mesh structure, assuming that the wind velocity is below (30 n/sec), it is calculated that each lighting unit undergoes a wind force around (2 g). If the wind is parallel to the mesh structure, the mesh structure is hardly influenced in any way as the linear members are stretched by forces at least 50 kg. If the wind is directly against (i.e., perpendicular to) the mesh structure, the mesh structure is concaved as shown in the profile diagram of FIG. 4. Assuming that equilibrium is reached under a constant wind flow (shown as the arrow heads), the breadth of concavity (A) can be obtained by the following equation derived form mechanics:

$$A ≅ \frac{f}{4 F} \frac{{L}^{2}}{P} \qquad ( 1 )$$

where (f) is the wind force perceived by a lighting unit 32, (F) is the stretching force applied to a linear member 30, (P) is the distance between adjacent lighting units or intersection points, and (L) is the length of the linear member. Assuming that (L)=30 m, (P)=6 cm, (F)=50 kg, (f)=2 g) (i.e., the wind velocity is below (30 m/sec), the breadth (A) is about (15 cm) according to equation (1). Compared to the linear member's length (i.e., 30 m), such a breadth is barely noticeable. As to how much the direction of the light beams from the lighting units 32 are affected, as can be seen from FIG. 4, the lighting units 32 at the two ends of the linear member 30 are most affected by the wind and their light beams are tilted by an angle (θ), which can be obtained by the following equation derived also by mechanics:

$$θ ≅ \frac{f}{F} \frac{L}{P} \qquad ( 2 )$$

Using the same set of sample data, the angle (θ) is about (1.15) degree according to equation (2). In other words, the influence of the wind on the light beams from the lighting units 32 is also quite insignificant. If the wind velocity is below (10 m/sec), the breadth of concavity (A) and the tilted angle (θ) should be even less noticeable. On the other hand, if the wind velocity is above (50 m/sec) (i.e., wind scale 15), the mesh structure will suffer a wind force that is three times of that when the wind velocity is (30 n/sec), and the breadth of concavity could reach (45 cm). Under these circumferences, the linear members should be stretched by greater forces to counteract the influence of the wind.

Another factor that needs to be addressed is the natural vibration of the mesh structure (and, thereby, the resonance of the lighting units), under the influence of the wind. Again, through mechanics, the frequency (ω) of the mesh structure's natural vibration can be obtained as follows:

$$2 πω ≅ 2 \sqrt{\frac{F}{mP}} \qquad ( 3 )$$

where (m) is the weight of the lighting unit. Assuming the weight (m) is (2 g) and assuming the same set of sample data as before, the frequency (ω) of natural vibration is about (650 Hz), which is much greater than the frequency of ordinary wind. In other words, the wind flow could hardly cause the natural vibration of the mesh structure and, therefore, there is no need to concern the resonance problem of the lighting units.

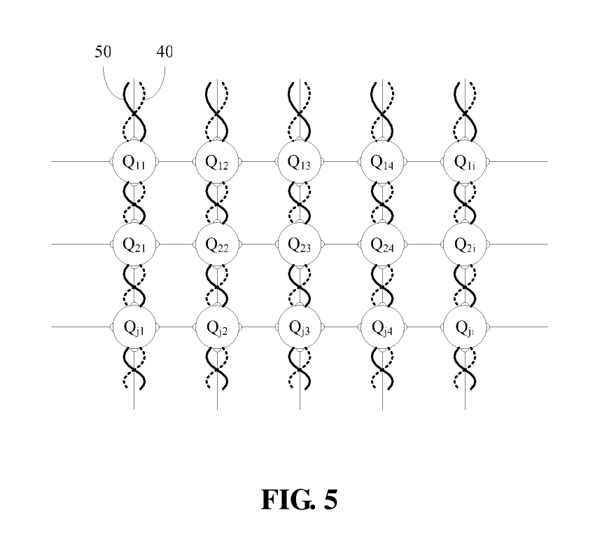

The video signal and electricity required by each lighting unit are delivered by signal and power cables, respectively. To avoid blocking the view and affecting the lighting condition by too many cables, the lighting units are preferably cascaded. In other words, the lighting units are series-connected by the signal and power cables. To guard against dust and moisture, special treatments to where the cables enter and leave each lighting unit should be adopted. As shown in FIG. 5, the lighting units can be connected by (i) signal cables 40 (shown as dotted lines) and (j) power cables 50 (shown as physical lines) substantially aligned in the same direction. The signal and power cables 40 and 50 are then connected to external signal and power sources, respectively. As illustrated, the signal and power cables 40 and 50 should be wound around the linear members so that, when the mesh structure vibrates, the signal and power cables 40 and 50 will not get lost.

Based on existing technology, a signal cable can be extended up to several tens of meters without causing distortions and infidelity to the transmitted signal and without incurring a significant power consumption (usually only up to several μW). As such, a rather thin signal cable having, for example, a diameter below (0.2 mm) can be adopted. For the lighting units, they can extract, process, and present those signals addressed only to them from the signal cable. As shown in FIG. 5, (i) video signals can be fed through the (i) signal cables 40, and the lighting units Q₁₁, Q₁₂, . . . , Q₁ᵢ on the first row gathers those addressed to them and then pass the (i) video signals to the lighting units Q₂₁, Q₂₂, . . . , Q₂ᵢ on the next row, and the process repeats until the (i) video signals reach the lighting units on the last row. Then, a complete image can be presented by the lighting units on the mesh structure. The details about the transmission and processing of the signals are omitted here as they are quite common to people of the related arts. Please note that there are various other ways to lay out the signal and power cables and to connect the lighting units, and the present invention should not be limited to only those shown in the drawings.

As the lighting units are usually driven by DC voltages which would suffer significant voltage drop over an extended distance, higher voltage should be applied to the power cables so as to provide enough electricity and power to the lighting units. Assuming that (500) lighting units are cascaded by a single power cable and assuming that each lighting unit has three LEDs, each requiring (20 mA) when lit, the (500) lighting units would require an average power of (60 W). If a DC voltage of (48 V) is applied, the average current is about (1.25 A). If the power cable has a diameter of (0.5 mm) and a length of (30 m), the end of the cable would perceive a voltage drop about (3.75 V), which is only about (8%) of the applied (48 V) voltage. If an even larger DC voltage is applied, an even smaller percentage of voltage drop would occur. In other words, for the mesh structure of the present invention, driving a large number of lighting units by DC voltages over a distance of several tens of meters are quite feasible.

Combining the foregoing discussion, the signal and power cables between any two adjacent lighting units can have a total diameter well within (1.5 mm). Again, assuming the distance between adjacent lighting units is (6 cm), the signal and power cables will only take up 3% (1.5 mm/6 cm) of the area of the mesh structure. Together with the 3% area taken up by the lighting units of a diameter of (1 cm), only 6% of the area of the large-scale display screen are not transparent (i.e., 94% of the area are transparent). The mesh structure of the present invention indeed render insignificant impact to a building's view and lighting condition.

Please note that positioning lighting units at the intersections of the linear members, as shown in FIGS. 3a and 3b, is not the only approach. FIGS. 3c and 3d are schematic diagrams showing two embodiments of positioning lighting units 32 inside the grids of the linear members 30 from a front view, respectively. As illustrated, to provide (n×m) lighting units 32, the mesh structure should provide at least (n×m) grids. Each grid contains additional linear segments 36 connected to the four corners of the grid (as shown in FIG. 3c), or connected to the four sides of the grid (as shown in FIG. 3d). The lighting units 32 are then positioned at the intersection of the linear segments 36. In alternative embodiments, the lighting units 32 has four outwardly extending legs to hook to the corners or the sides of the grid as shown in FIGS. 3c and 3d. Please note that there are various other approaches to configure the lighting units inside the grids of the mesh structure. In addition, the foregoing discussion about the influence of the wind, natural vibration, and how the signal and power cables are laid out should also apply to the embodiments where the lighting units are positioned inside the grids. These discussions are therefore not repeated here.

The present invention is especially beneficial in terms of construction. For example, for a large-scale display screen having a dimension of (30 m×30 m) and a resolution of (500×500), there are (250,000) lighting units and (1,000) linear members (assuming that the lighting units are positioned at the intersections of the linear members). If each lighting unit weighs (2 g), the weight of all lighting units is about (500 kg). If Kevlar wires of a diameter of (1 mm) are used as linear members, the weight of all linear members is about (34 kg). The signal and power cables weigh about (200 kg). Together, the entire large-scale display screen has a total weight about (800 kg). In contrast, a conventional module-based large-scale display screen of comparable dimension and resolution has an average weight about (50 kg/m²) and the total weight is about (50×30×30=45,000 kg), much greater than the (800 kg) of the present invention. The significant reduction of weight would greatly simply the construction of the large-scale display screen. In addition, the mesh structure can also be formed by piecing together smaller pre-prepared mesh structures, which will make the construction work even simpler.

Further more, the cost of the linear members is much lower than that of the conventional modules. The tenacity of the linear members can almost guarantee that the large-scale display screen is free from the damage of natural factors such as wind, rain, dust, and earthquake. The maintenance work therefore is simpler as well. When some lighting units are out of order, only those broken ones need to be replaced, in contrast to the conventional large-scale display screen where one or more entire modules have to be removed and re-installed. The cost of maintenance is therefore lower too.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mesh structure for a large-scale display screen having a resolution of (n×m, n, m>1) comprising:
(i+j, i, j>1) linear members weaving into a mesh plane;
(n×m) lighting units individually and fixedly positioned on said mesh plane, each having a substantial uniform distance to adjacent lighting units; and
a plurality of signal and power cables positioned along said linear members to connect said lighting units so as to distribute video signal and electricity to said lighting units.

2. The mesh structure according to claim 1, wherein said (i+j) linear members forms (n×m) intersections; and said (n×m) lighting units are positioned at said (n×m) intersections, respectively.

3. The mesh structure according to claim 2, wherein each lighting unit is fixed to appropriate locations on said linear members forming said intersection where said lighting unit is positioned.

4. The mesh structure according to claim 1, wherein said (i+j) linear members forms (n×m) grids; and said (n×m) lighting units are positioned inside said (n×m) grids, respectively.

5. The mesh structure according to claim 4, wherein each lighting units is fixed to the corners of said grid in which said lighting unit is positioned.

6. The mesh structure according to claim 1, wherein each lighting units is fixed to the sides of said grid in which said lighting unit is positioned.

7. The mesh structure according to claim 1, wherein (i) linear members are aligned substantially in parallel in a first direction; the other (j) linear members are aligned substantially in parallel in a second direction; and each linear member is stretched by appropriate opposite forces from the two ends of said linear member.

8. The mesh structure according to claim 7, wherein at least one of said (j) linear members are wound around said (i) linear members as said linear member intersects said (i) linear members, respectively.

9. The mesh structure according to claim 7, wherein said first and second directions are orthogonal.

10. The mesh structure according to claim 1, wherein (i) linear members are aligned substantially in parallel in a first direction; each of said (i) linear members is stretched by appropriate opposite forces from the two ends of said linear member; the other (j) linear members are aligned substantially in parallel in a second direction; and at least one of said (j) linear members is wound around said (i) linear members as said linear member intersects said (i) linear members, respectively.

11. The mesh structure according to claim 10, wherein said first and second directions are orthogonal.

12. The mesh structure according to claim 7, wherein each of said linear members has two adjacent linear members except those at the boarders of said mesh plane;
and each of said linear members except those at the boarders of said mesh plane braids with said adjacent linear members back and forth.

13. The mesh structure according to claim 1, wherein at least one of said signal and power cables series-connects said lighting units.

14. The mesh structure according to claim 1, wherein at least one of said signal and power cables is wound around one of said linear members.

15. The mesh structure according to claim 1, wherein each of said lightning units contains an appropriate number of LEDs having at least one light color.

16. The mesh structure according to claim 1, wherein at least one of each lighting units contains a transparent dome and a base.

17. The mesh structure according to claim 1, wherein each of said linear members is one of a nylon polymer wire, a Kevlar polymer wire, and a steel wire.
